(19) United States
(12) Patent Application Publication
(10) Pub. No.: US 2017/0195819 A1
(43) Pub. Date: Jul. 6, 2017

(54) Configuring Playback of Audio Via a Home Audio Playback System

(71) Applicant: DOLBY INTERNATIONAL AB, Amsterdam Zuidoost (NL)

(72) Inventors: Sigrid HARDER, Nuremberg (DE); Robert Andrew FRANCE, Bristol (GB); Thomas ZIEGLER, Nuremberg (DE); Radoslaw MUSIAL, Wroclaw (PL); Christopher OATES, Nuremberg (DE)

(73) Assignee: DOLBY INTERNATIONAL AB, Amsterdam Zuidoost (NL)

(21) Appl. No.: 15/313,095

(22) PCT Filed: May 20, 2015
(86) PCT No.: PCT/EP2015/061138

§ 371 Date: Nov. 21, 2016

Related U.S. Application Data
(60) Provisional application No. 62/001,193, filed on May 21, 2014.

(51) Int. Cl. H04S 7/00; H04S 3/00; G06F 3/16

(52) U.S. Cl. CPC H04S 7/40; G06F 3/165; H04S 3/008; H04S 7/30; H04S 2400/11; H04S 2400/01

(57) ABSTRACT

Method and apparatus is described relating to configuring playback of audio via a home audio playback system. The method relates to a graphical user interface, where the graphical user interface comprises a positioning area. Control objects representing audio objects are movable by the user to different locations in the position area, where the current location of the control object represents a user-desired playback position in a listening environment. A method also relates to configuring playback of audio with a graphical user interface comprising a balance adjustment area. In the balance adjustment area of the user interface the user can select a volume level for foreground and background objects.

### CROSS-REFERENCE TO RELATED APPLICATIONS

This application claims the benefit of priority to U.S. Provisional Patent Application No. 62/001,193 filed 21 May 2014, which is hereby incorporated by reference in its entirety.

### FIELD OF THE INVENTION

The invention relates to configuring the playback of audio via a home audio playback system, where the audio comprises one or more audio objects.

### BACKGROUND OF THE INVENTION

A typical home audio playback system is arranged to receive and play back audio in a home listening environment. Such a home audio playback system may comprise an Audio Video Receiver (AVR) connected to multiple speakers in a surround sound configuration so as to play back audio via the speakers, e.g. in a home living room or home cinema room. For instance, the AVR may be connected to six speakers in a 5.1 surround sound configuration or eight speakers in a 7.1 surround sound configuration. That is, such an AVR may be configured to playback audio via 6, 8, or in the future even more speaker channels.

The played back audio may be based on a received object-based audio program. The object-based audio program may comprise many different audio objects, e.g. up to 128 different audio objects in some modern formats.

Clearly, if a home audio playback system having 6, 8 or even more speaker channels is to play back audio from an object-based audio program comprising up to 128 audio objects, then there will be many possible permutations of which of the audio objects are to be played back and via which of the speaker channels.

### SUMMARY OF THE INVENTION

The present disclosure provides a method for configuring playback of audio via a home audio playback system, the audio comprising one or more audio objects, the method comprising:
generating an output signal for a display, the output signal comprising data representing a graphical user interface, the graphical user interface (GUI) comprising a positioning area, wherein the positioning area comprises a visual representation of a listening environment associated with the home audio playback system, and
   wherein the positioning area comprises a movable control object which represents at least one of said one or more audio objects, the movable control object being movable with respect to the visual representation of the listening environment, whereby a current location of the movable control object can be selected by a user, the current location of the movable control object being representative of a user-desired playback position within the listening environment for the at least one of the one or more audio objects,
receiving an input signal from the user via an input device, the input signal comprising data representative of the user-desired playback position for the at least one of the one or more audio objects; and
generating a configuration signal for configuring the home audio playback system, the configuration signal comprising data suitable for causing the home audio playback system to playback the at least one of the audio objects according to the user-desired playback position for the at least one of the one or more audio objects.

Thus, in the method it is suggested to make it possible for the user to choose an apparent playback position within the listening environment where the user wants the sound to appear.

In an embodiment the positioning area comprises a first visual element with a visual indication that the at least one of the one or more control objects has been selected by the user. When a control object is selected in an object selection list area e.g. an icon representing that control object is shown in the positioning area.

The positioning area may also comprise a second visual element with a visual indication that the movable control object is movable, or wherein the first visual element comprises the visual indication that the movable control object is movable. For example the control object can have a specific shape when it is movable or just being movable along a circumference of a circle.

The first visual element may also comprise a visual indication when the control object is active. A control object is active when the audio object that the control object represents carries sound. For example when a commentator is speaking the control object is active. An icon that represents the control object on the positioning area may have a special color or highlighting when it is active. This makes it easy for the user to identify the control objects and move selected control objects to certain places in the listening environment.

In an embodiment, the positioning area comprises a further visual element arranged to indicate at least one valid location with respect to the visual representation of where the one or more speakers are located, the valid location being a location which the movable control object can occupy. Depending on the speaker set-up, the user can see on the positioning area of the GUI where it would be possible to place the audio objects. E.g it may be along a circumference of a circle.

Further it is possible to determine a respective content of control object of the, or each of the, audio objects. In one embodiment the respective content is any one of:
representative of commentary;
representative of crowd noise;
representative of team radio; or
representative of social media chat.

In a further embodiment, the graphical user interface further comprises an object selection list area, wherein the object selection list area comprises at least one selectable control object, the at least one selectable control object being configured to allow the user to enable playback of one or more of the control objects. If the user enables control objects in the object selection list area they will show up in the positioning area.

The object selection list area also may comprise at least one further selectable control object, the at least one further selectable control object being configured to allow the user to select a playback volume of the one or more enabled control objects.

The object selection list area may comprise plural control objects, and the control objects are arranged into plural groups in the object selection list area. The number of control objects and the allocation of control objects to the groups are based on the respective content of the control objects. E.g. the user may find all audio objects with a certain audio content under a common group.

In one embodiment the home audio playback system receives information related to the audio, the audio-related information comprising resources specific for a current program of the audio, wherein the resources comprise images for object icons to be displayed in association with the control object(s) in the object selection list area and/or in the positioning area. The resources for a current program are downloaded through a file transfer protocol (FTP) link.

This embodiment makes it possible to have pre-determined programs for each sporting event. In for example a motor sports event, a specific icon can be team radio.

The home audio playback system may comprise two or more speakers which are arranged according to one of:
a 2.0 speaker configuration,
a 5.1 speaker configuration,
a 7.1 speaker configuration,
a 3D speaker configuration or
a sound bar speaker configuration.

Further embodiments comprise determining, from the input signal, a user command to store the selection of the one of the control objects as a preset but can also comprise a user command to store the user-desired playback position as a preset.

Further embodiment comprises communicating the configuration signal to the home audio playback system. This can be done by using an Internet-based protocol.

A further embodiment relates to a method of configuring playback of audio via a home audio playback system, the audio comprising two or more audio objects, the method comprising:
generating an output signal for a display, the output signal comprising data representing a graphical user interface, the graphical user interface comprising a balance adjustment area, wherein the balance adjustment area comprises:
   a first icon at a first position, the first icon representing one or more of the audio objects which are foreground objects,
   a second icon at a second position, the second icon representing one or more of the audio objects which are background objects,
   a movable control object which is movable between the first position and the second position whereby a current position of the movable control object can be selected by the user, the current position of the movable control object relative to the first position being representative of a user-selected volume level for the one or more foreground objects, the current position of the movable control object relative to the second position being representative of a user-selected volume level for the one or more background objects;
receiving an input signal from the user via an input device, the input signal comprising data representative of the user-selected volume level for the one or more foreground objects and data representative of the user-selected volume level for the one or more background objects; and
generating a configuration signal for configuring the home audio playback system, the configuration signal comprising data suitable for causing the home audio playback system to playback the two or more audio objects according to the respective user-selected volume levels for the one or more foreground objects and the one or more background objects.

This method makes it possible to use only one control object for effecting two actions. When moving the control object it will result in an increase of the volume level of certain pre-selected audio objects and at the same time decrease the volume level of other pre-selected audio objects. If the user wants to increase intelligibility of foreground objects and decrease volume of background objects, the user increases the volume level for these foreground objects with the balance adjuster by moving the balance adjuster to the first position. This will at the same time result in a decrease in volume level for the background objects.

In one embodiment the movable control object may be a slider which is movable in a straight line between the first and second position. A slider would make it easy and flexible to only need one control object for effecting two actions.

In one embodiment it is possible to determine from the input signal, a user command to store:
the one or more background and the one or more foreground objects as presets;
the volume level of the background objects as a preset;
the volume level of the foreground objects as a preset.

This embodiment would make it comfortable to know where the audio objects are positioned in the listening environment at a specific preset and what volume levels the different audio objects have for a specific preset.

This embodiment would work well for example with two or more speakers which are arranged according to one of:
a 2.0 speaker configuration,
a 5.1 speaker configuration,
a 7.1 speaker configuration,
a 3D speaker configuration or
a sound bar speaker configuration.

The embodiments as recited above for the methods are also applicable to the respective apparatus.

In a further embodiment, the corresponding apparatus would be suitable to receive the input signal via wireless communications channel such as IR-channel and transmit the output signal via a wired channel such as for example HDMI, VGA, DVI or SCART cable.

In a further embodiment of the apparatus, the display and the input device are integrated in a touch screen.

The objective of the present disclosure is also achieved by a home audio playback system as claimed in claim 57 and a broadcasting system as claimed in claim 58.

### BRIEF DESCRIPTION OF DRAWINGS

FIG. 1 shows an overview of an embodiment of a broadcast system which is transmitting signals to a home playback system.

FIG. 2 shows in more detail an embodiment of the home playback system as shown in FIG. 1.

FIG. 3 shows in more detail an embodiment of the home playback system as shown in FIG. 2.

FIG. 4 shows an overview of signaling of a processing unit of user control unit 303 in FIG. 3.

FIG. 5 shows a flowchart of generating an output signal of the processing unit as in FIG. 4.

FIG. 6 shows an overview of a graphical user interface produced on an output device as in FIG. 4.

FIG. 7 shows a detailed view of the positioning area of the graphical user interface as shown in FIG. 6.

FIG. 8 shows an embodiment of the graphical user interface to control volume of audio objects as shown in FIG. 6.

FIG. 9 shows a flowchart of user interaction with the graphical user interface via a user input device.

FIG. 10 shows a flowchart of processing the signaling of a user input from the user interaction of FIG. 9.

### NOTATION AND NOMENCLATURE

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the expression “audio video receiver” (or “AVR”) denotes a receiver in a class of consumer electronics equipment used to control playback of audio and video content, for example in a home theater.

Throughout this disclosure including in the claims, the expression “soundbar” denotes a device which is a type of consumer electronics equipment (typically installed in a home theater system), and which includes at least one speaker (typically, at least two speakers) and a subsystem for rendering audio for playback by each included speaker (or for playback by each included speaker and at least one additional speaker external to the soundbar).

Throughout this disclosure including in the claims, the expression “metadata” (e.g., as in the expression “processing state metadata”) refers to separate and different data from corresponding audio data (audio content of a bitstream which also includes metadata). Metadata is associated with audio data, and indicates at least one feature or characteristic of the audio data (e.g., what type(s) of processing have already been performed, or should be performed, on the audio data, or the trajectory of an object indicated by the audio data). The association of the metadata with the audio data is time-synchronous. Thus, present (most recently received or updated) metadata may indicate that the corresponding audio data contemporaneously has an indicated feature and/or comprises the results of an indicated type of audio data processing.

Throughout this disclosure including in the claims, the following expressions have the following definitions:
speaker and loudspeaker are used synonymously to denote any sound-emitting transducer. This definition includes loudspeakers implemented as multiple transducers (e.g., woofer and tweeter);
channel (or “audio channel”): a monophonic audio signal. Such a signal can typically be rendered in such a way as to be equivalent to application of the signal directly to a loudspeaker at a desired or nominal position. The desired position can be static, as is typically the case with physical loudspeakers, or dynamic;
audio program: a set of one or more audio channels (at least one speaker channel and/or at least one object channel) and optionally also associated metadata (e.g., metadata that describes a desired spatial audio presentation);
speaker channel (or “speaker-feed channel”): an audio channel that is associated with a named loudspeaker (at a desired or nominal position), or with a named speaker zone within a defined speaker configuration. A speaker channel is rendered in such a way as to be equivalent to application of the audio signal directly to the named loudspeaker (at the desired or nominal position) or to a speaker in the named speaker zone;
object channel: an audio channel indicative of sound emitted by an audio source (sometimes referred to as an audio “object”). Typically, an object channel determines a parametric audio source description (e.g., metadata indicative of the parametric audio source description is included in or provided with the object channel). The source description may determine sound emitted by the source (as a function of time), the apparent position (e.g., 3D spatial coordinates) of the source as a function of time, and optionally at least one additional parameter (e.g., apparent source size or width) characterizing the source;
object based audio program: an audio program comprising a set of one or more object channels (and optionally also comprising at least one speaker channel) and optionally also associated metadata (e.g., metadata indicative of a trajectory of an audio object which emits sound indicated by an object channel, or metadata otherwise indicative of a desired spatial audio presentation of sound indicated by an object channel, or metadata indicative of an identification of at least one audio object which is a source of sound indicated by an object channel); and
render: the process of converting an audio program into one or more speaker feeds, or the process of converting an audio program into one or more speaker feeds and converting the speaker feed(s) to sound using one or more loudspeakers (in the latter case, the rendering is sometimes referred to herein as rendering “by” the loudspeaker(s)). An audio channel can be trivially rendered (“at” a desired position) by applying the signal directly to a physical loudspeaker at the desired position, or one or more audio channels can be rendered using one of a variety of virtualization techniques designed to be substantially equivalent (for the listener) to such trivial rendering. In this latter case, each audio channel may be converted to one or more speaker feeds to be applied to loudspeaker(s) in known locations, which are in general different from the desired position, such that sound emitted by the loudspeaker(s) in response to the feed(s) will be perceived as emitting from the desired position. Examples of such virtualization techniques include binaural rendering via headphones (e.g., using Dolby Headphone processing which simulates up to 7.1 channels of surround sound for the headphone wearer) and wave field synthesis.
control object: a part of a user interface that a user can manipulate in order to control something.
active control object: a control object which represents an audio object which currently carries sound.

### DETAILED DESCRIPTION OF THE INVENTION

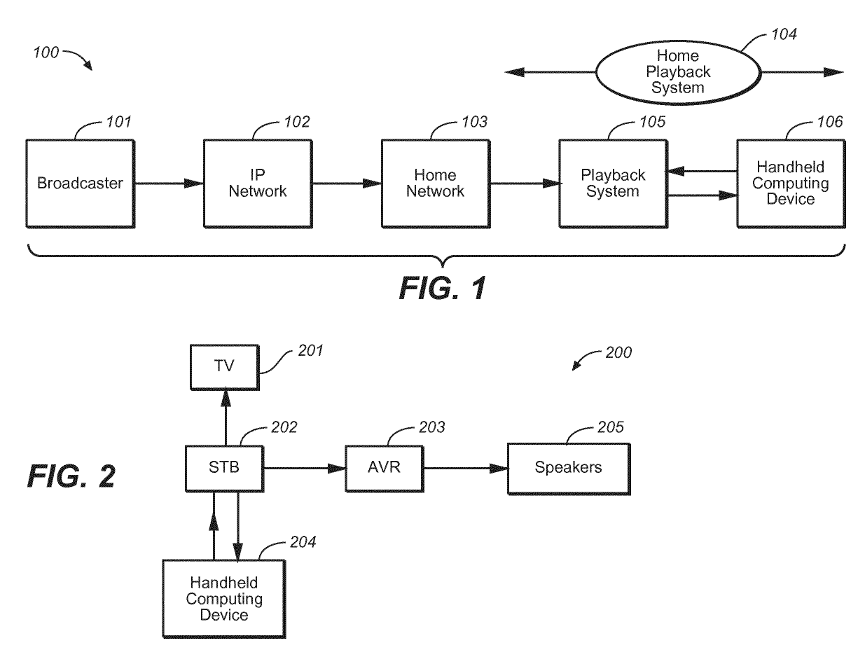

With reference to FIG. 1, a broadcasting system according to an embodiment of the invention comprises a broadcaster 101 configured to broadcast audio and video of a sports event, e.g. a soccer match. Captured audio and video can be broadcasted e.g. to a television (TV), a desktop computer, a laptop, a tablet computer or the like. The broadcaster 101 can transmit the captured audio and video as digital information over an IP network 102 (e.g. including the Internet) to be received by a home network 103. The home network 103 is arranged to distribute the information wirelessly or with a wired connection to a home playback system 104. If the information is communicated through a wireless connection, it can be sent e.g. through a router via WIFI or through Bluetooth. As shown in FIG. 1, the home playback system 104 may comprise a playback system 105 and a handheld computing device 106.

In FIG. 2, an example of the home playback system of FIG. 1 is shown. The home playback system 200 comprises a television (TV) 201, a set-top box (STB) 202, an audio video receiver (AVR) 203 and speakers 205. Alternatively, in some embodiments, the AVR 203 and the speakers 205 can be replaced by a soundbar.

In this embodiment, a handheld computing device 204 interacts with the home playback system 200. The handheld computing device 204 is preferably a tablet computer, a mobile phone or the like.

The TV 201 typically communicates with the STB 202 and the AVR 203 through a wired connection or a wireless connection. The wired connection is preferably via a cable like an HDMI (High Definition Multimedia Interface), VGA (Video Graphics Array), SCART (Syndicat des Constructeurs d'Appareils Radiorécepteurs et Téléviseurs), or DVI (Digital Visual Interface) cable, or similar. The speakers 205 may have a wired or wireless connection to the AVR 203. The handheld computing device 204 may have a wired or wireless connection to the STB 202.

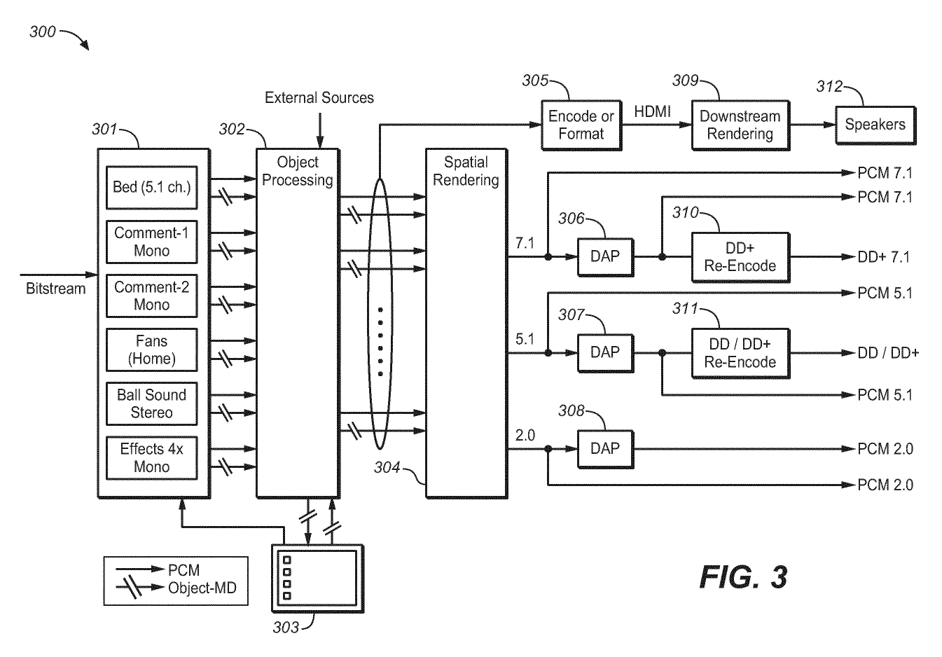

As shown in FIG. 3, the home playback system of FIG. 2 comprises a decoder 301, an object processing unit 302, user control unit 303, a spatial renderer 304, a digital audio processing subsystems 306, 307, 308 and re-encoders 305, 310, 311. The decoder 301, object processing unit 302, digital audio processing subsystems 306, 307, 308 and re-encoders 305, 310, 311 are preferably be part of the STB 202.

A downstream renderer 309 may be part of the AVR 203 (or a soundbar), and is configured to render audio for playback to the speakers 205 in the home playback system.

The user control unit 303 is preferably the handheld computing device 204.

The decoder 301 receives audio related data in a bit stream, e.g. an AC-3 encoded bit-stream.

The audio comprises audio objects. The bit-stream comprises data informing of available audio objects in the bit-stream.

With the user control unit 303 a user can select which audio objects to render. The user control unit 303 may be the handheld computing device 204 which is programmed to implement a graphical user interface (GUI). The GUI may provide to the user a menu of selectable “preset” mixes of objects and speaker channel content. The decoder decodes the channels of the selected audio objects, and outputs to the object processing unit 302 these selected audio object channels and object related metadata corresponding to the selected object channels.

The object processing unit 302 is controlled by control data from the user control unit 303 and object related metadata from decoder 301 and is configured to determine inter alia a spatial position and audio level for each of the selected objects.

The spatial rendering system 304 is configured to render the audio objects from object processing unit 302 for playback by speakers 312 of the home playback system. The spatial rendering system map to available speaker channels, the audio channels which has been selected by object processing unit 302 using the rendering parameters output from object processing unit 302.

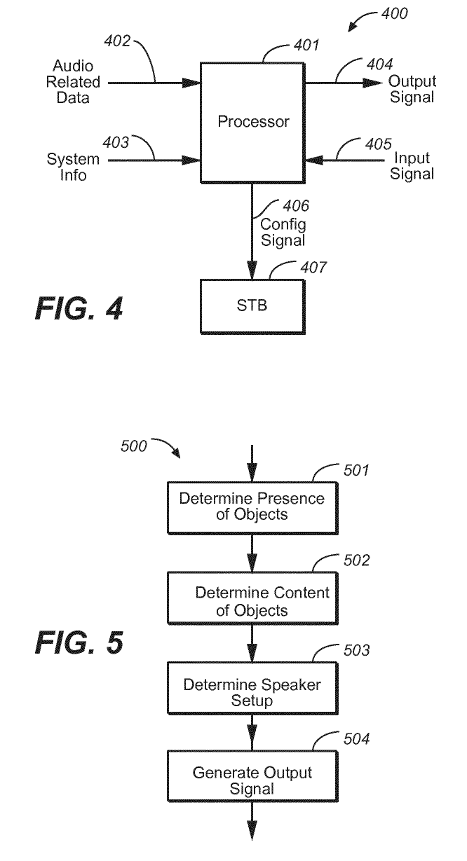

FIG. 4 shows signaling of a processor 401 inside user control unit 303. Data relating to the audio is obtained via a wireless communications channel. This audio-related data 402 is derived, such as metadata of the bit-stream e.g. as specified in the AC-3 standard or the E-AC-3 standard.

FIG. 5 is a flowchart showing the steps of a method performed by the process shown in FIG. 4.

From the audio-related data 402 the processor 401 determines 501 presence of audio objects. The processor 401 then determines 502 an audio content for each of the audio objects.

The respective content of the audio objects may be captured audio of any of: commentary, fan crowd, team radio, extras or social media chat. The commentary can be captured audio of a commentator for home fans, for away fans, for radio, or alternative commentaries e.g in different languages. The fan crowd may comprise home, away or neutral crowd noise. The team radio may comprise radio communication between driver and engineer when watching a motor sports event. Extras may comprise stadium announcements (e.g. substitutions of players, emergency information), or a goal flash from other events. Social media chat may comprise text messages exchanged between friends during a game or a race. The text may be converted to speech by using Text-To-Speech (TTS) synthesis.

The processor 401 receives information related to the audio. The processor 401 may use a file transfer protocol (FTP) link to download resources specific for a current program. The current program can be a sporting event e.g. a rugby game, a soccer game or another sporting event. For each of the programs there are predefined resources. The resources are mainly images with icons or bars that are displayed on the GUI.

The processor 401 also obtains system information 403, e.g. by retrieving the system information from a memory. The system information may have been saved to the memory during a discovery phase.

From the system information, playback capability of the user's audio system is received. Depending on the user's audio playback system a speaker configuration of one or more speakers can be determined 503 for the home audio playback system 200.

The speaker configuration can e.g. be any one of: a 2.0 speaker set-up, a 5.1 set-up, a 7.1 set up, a 3D set-up or a soundbar set-up.

The processor 401 is then generates 504 the output signal 404 for an output device. For example the output device can in various embodiments comprise a display. The display may be integrated in a touch screen of the handheld computing device 204.

Depending on the output device the output signal can be transmitted via a wireless communications channel, or wired channel via a HDMI, VGA, SCART or DVI cable.

The output signal 404 can comprise data which is suitable for causing the output device to present to a user an indication of which audio objects are present in the audio. At least part of the data is suitable for causing the output device to generate a graphical user interface (GUI) 600.

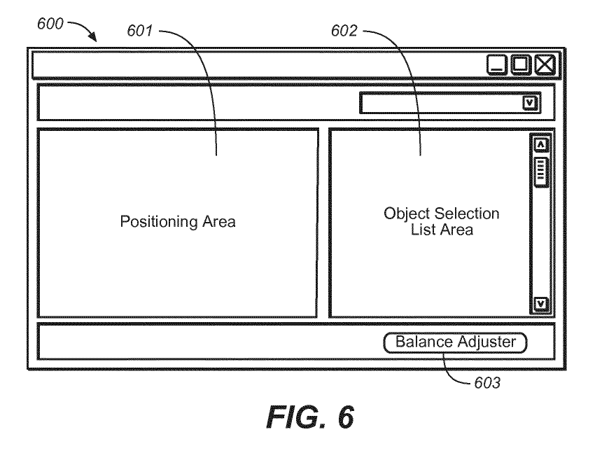

FIG. 6 shows an overview of the different areas of the GUI 600, which comprises an object selection list area 602, a positioning area 601 and a balance adjustment area 603. The object selection list area 602 comprises at least one control object. The control object(s) are configured to allow the user to enable playback of one or more of the audio objects. E.g each control object may be a rectangular element, selectable by a user in order to select of one or more audio objects associated with the control object, and with text inside identifying the element and highlighted with a color such as red or blue when the control object has been selected. It may be gray if it has not been selected.

In some embodiments the object selection list area 602 may comprise at least one further control object configured to allow the user to select a playback volume of at least one of the audio objects. This further control object need not be in the object selection area 602.

The control objects may be arranged in plural groups in a list in the object selection list area. The number of control objects in the groups, and allocation of control objects to the groups may be based on the respective content of the control objects that is predetermined by a Content creator. The object selection list area may be a scrollable region if there are many control objects such as 16 control objects.

When the control objects are selected in the object selection list area the respective control object will appear in the positioning area. In the positioning area these control objects may be visualized as icons.

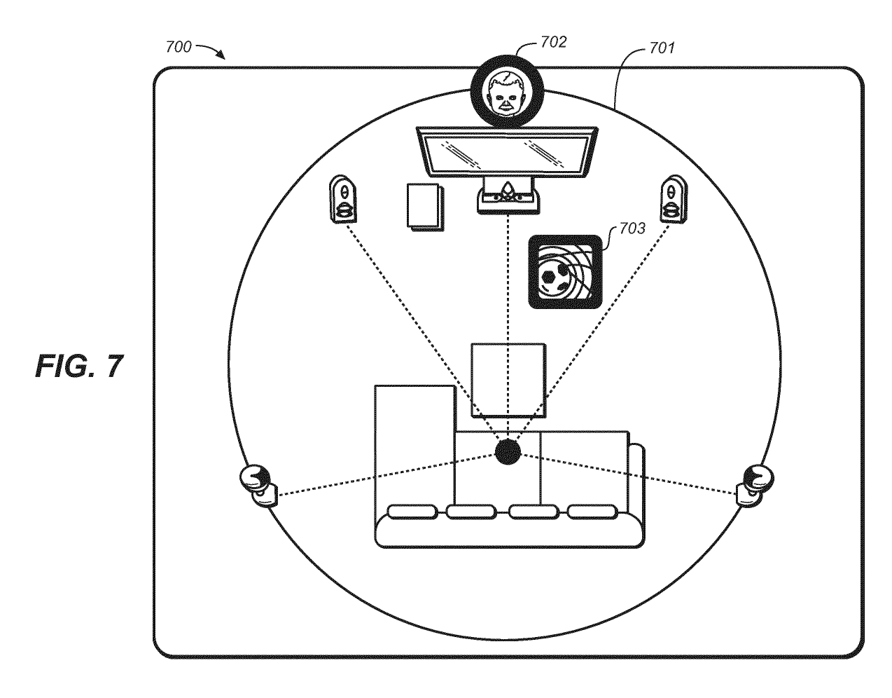

As shown in FIG. 7, the positioning area 601, 700 comprises a visual representation 700 of a listening environment. The positioning area 601, 700 can for example be shown as an image that shows where the speakers are positioned around a sofa and TV in a living room.

A 2.0 speaker set-up area is limited to an angle of −/+45 degrees from the center of the listening area. A 5.1 speaker set-up area is limited to a circle, which has an angle of 360 degree from the center of the listening area. A 7.1 speaker set-up area is limited to a circle, which has an angle of 360 degree from the center of the listening area.

A 3D set-up area is limited to half of a sphere of the listening area. A soundbar set-up area is also limited to half of a sphere of the listening area.

The positioning area 601, 700 comprises of at least one movable control object 702 which represents one of the enabled control objects in the object selection list area. This movable control object 702 is movable with respect to the visual representation. As shown in FIG. 7, the movable control objects 702 may be moveable around a perimeter 701 of the listening area, which may be the circumference of a circle 701. The size of the circle depends on the speaker configuration.

The current location of the movable control object 702 is selected by the user, as will be discussed below with reference to FIG. 9. Thus the current location of the movable control object 702 is representative of a user-desired playback position within the listening environment for the selected one of the control objects.

The positioning area 601, 700 may comprise a first visual element which is a visual indication that the at least one of the one or more control objects has been selected by the user. E.g. an icon is shown in the positioning area. The first visual element can further comprise a visual indication of whether a control object is movable, or the positioning area can comprise a second visual element with a visual indication that the movable control object is movable. As shown in FIG. 7, the icon can for example be circle shaped 702 when it is movable and square shaped when it is non-movable 703.

The first visual element may also comprise a visual indication when the control object is active. For example, an icon that represents the control object may be highlighted blue, when the audio object carries sound, e.g. wherein a commentator is speaking.

The positioning area 700 may also comprise a further visual element arranged to indicate at least one valid location with respect to the visual representation in the listening environment, the valid location 701 being a location which the movable control object 702 can occupy. It also comprises a visual indication of at least one invalid location, the invalid location being a location which the movable control object cannot occupy. The control objects 702 in the positioning area 700 are movable along the circumference of the circle 701, which may be e.g. displayed in red in order to visually indicate to the user that the movable control object 702 can occupy any point on the circumference. When the user is moving the icon in allowable positions on the circumference of the circle in the positioning area, the icon is typically highlighted with a green/red shadow around the icon.

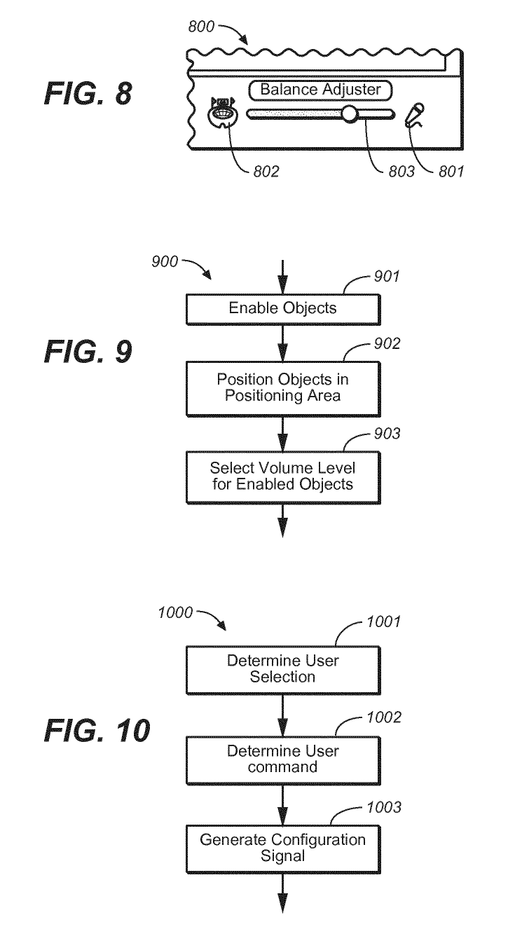

As shown in FIG. 8, the audio volume of the audio objects can be controlled by a movable control object 803 in a balance adjustment area 800 of the GUI 600. The balance adjustment area 800 comprises a first icon at a first position. This first position can be in a right-hand or upper part of the balance adjustment area 800. This first icon represents one or more of the audio objects, which are foreground objects 801.

Further the balance adjustment area comprises a second icon at a second position. This second position can be in a left-hand or lower part of a balance adjustment area. The second icon represents one or more of the audio objects which are background objects 802. A movable control object is movable between the first position and the second position whereby a current location of the movable control object can be selected by the user. The current position of the movable control object relative to the first position is representative of a user-selected volume level for the one or more foreground objects 801. The current position of the movable control object relative to the second position is representative of a user-selected volume level for the one or more background objects 802.

The audio objects that are possible to be background 802 and foreground objects 801 are pre-selected by a Content creator through metadata. The metadata is specific dependent on the different type of applications and can e.g. be sent in the bit-stream or be sent as external metadata.

In one embodiment the movable control object may be a slider which is movable along a straight line. If the slider is moved to the right (or upwards) the slider increases audio volume for foreground objects 801 and at the same time decreases audio volume for the background objects 802. The user might for example want to increase intelligibility of foreground objects that he would like to hear better and decrease the volume of background ambience that he still wants to hear but at a lower volume.

If the slider is moved to the left (or downwards) the audio volume increases for the background objects 802 and decreases for foreground objects 801. In this way only one control object is needed for effecting two actions (increasing and decreasing audio volume for pre-selected audio object(s) at the same time).

The volume level of the background 802 and foreground objects 801 can also be stored as presets.

In FIG. 9 a flowchart describes user interaction with the GUI via a user input device. In this embodiment the user input device is part of a touch screen of user control unit 303. On the object selection list area 602 of the GUI the user enable control objects 901 which he would like to use. On the positioning area 601, 700 the user then positions the control objects 902 by moving them to available positions on the circle of 701. On the GUI the user further selects a volume level for the background and foreground objects 903 with the balance adjuster 803. The input signal is typically received by the processor 401 via a wireless communications channel such as an infrared (IR) channel.

In one example of a use scenario, there is a 5.1 speaker configuration for a home playback system as in FIG. 7.

Three control objects are selected out of the possible 5 control objects. The respective three control objects have captured audio content of a home team commentator, a social media chat, and home team crowd noise. In this example the 5.1 speaker configuration makes it possible to position the control objects along the circumference of a circle as in FIG. 7.

In the positioning area of the GUI the user will see a visual representation of the speaker set-up in the home playback environment. In the object selection list area the user will see the control objects. The control objects may on the object selection list area 602 appear as element bars and on the positioning area as icons. The user can select some of the control objects and these bars may then get blue colored. The selected control objects will then appear as icons on the positioning area 601.

The user may for example position the home team commentator icon along the circumference of the circle to the left of the TV, the social media chat icon along the circumference of the circle to the right of the TV and the team crowd noise icon along the circumference of the circle behind the sofa. The user will then in his living room hear the audio of the home team commentator as it appears from left of the TV, the audio of the social media chat as it appears from the right of the TV and the audio of the home team crowd noise as it appears from behind the sofa. The user can then on the GUI 600 of the handheld device move a slider which controls the audio volume level of the foreground objects (the home team commentator and the social media chat in this example) and the background audio objects (home team crowd noise). If it is desirable to decrease the audio volume of the home crowd noise and at the same time increase the audio volume of the home team commentator and the social media chat, the slider is moved towards the first icon 801.

FIG. 10 present steps performed by the processor 401 in response to user input via the user input device.

The processor 401 receives an input signal 405 from the user input device. The input signal comprises data representative of:
the user-desired playback position 1001 for the at least one of the one or more audio objects,
the user-selected volume level 1001 of one or more background and foreground objects,
the user-selected audio objects 1001 to play back via the home audio playback system and data indicative for determining a user command 1002 to enable positioning and/or setting a playback volume level of the one or more audio objects.

The input signal also comprises data indicative for determining a user command 1002 to store the selection of the one of the audio objects as a preset, to store the perceived spatial position relative to the speaker configuration as a preset and/or to store the playback volume level as a preset.

The processor 401 then generates a configuration signal 406, 1003 for configuring the home audio playback system. The configuration signal data is suitable for causing the home audio playback system to selectively play back one or more audio objects.

Said data is suitable for causing the home audio playback system to perform at least one of: playback one of the audio objects according to a user-desired playback position; playback two or more audio objects according to respective user-selected volume levels for one or more foreground objects and one or more background objects.

The configuration signal data is also using presets to store predefined configurations of enabled audio objects, positions and volume for the enabled objects. The different types of presets for the audio object are preferably:
i. default which is prepared by a content creation and transmitted with a bit-stream,
ii. predefined, which are alternative presets also prepared by content creation
iii. user presets which are saved by the user.

Said data is also suitable to recall presets any time to restore object configuration, and is suitable to communicate with the audio playback system over a protocol as Transmission Control Protocol/Internet Protocol (TCP/IP.)

The present disclosure describes various example embodiments below, with reference to the drawings. It is to be noted that, for purpose of clarity, representations and descriptions of components and processes which are known to those skilled in the art, but which are not necessary to understand the various example embodiments, are omitted in the drawings and the description.

As will be appreciated by one skilled in the art, aspects of the present application may be embodied as a system, a device (e.g., a cellular telephone, a portable media player, a personal computer, a server, a television set-top box, or a digital video recorder, or any other media player), a method or a computer program product. Accordingly, aspects of the present application may take the form of an hardware embodiment, an software embodiment (including firmware, resident software, microcodes, etc.) or an embodiment combining both software and hardware aspects that may all generally be referred to herein as a “circuit,” “module” or “system.” Furthermore, aspects of the present application may take the form of a computer program product embodied in one or more computer readable mediums having computer readable program code embodied thereon.

Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic or optical signal, or any suitable combination thereof.

A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired line, optical fiber cable, RF, etc., or any suitable combination of the foregoing.

Computer program code for carrying out operations for aspects of the present application may be written in any combination of one or more programming languages, including an object oriented programming language such as Java, Smalltalk, C++ or the like and conventional procedural programming languages, such as the “C” programming language or similar programming languages. The program code may execute entirely on the user's computer as a stand-alone software package, or partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present application are described below with reference to flowchart illustrations and/or block diagrams of methods, apparatus (systems) and computer program products according to embodiments of the application. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While implementations have been described by way of example and in terms of exemplary specific embodiments, it is to be understood that implementations of the invention are not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of configuring playback of audio via a home audio playback system, the audio comprising one or more audio objects, the method comprising:
generating an output signal for a display, the output signal comprising data representing a graphical user interface, the graphical user interface comprising a positioning area, wherein the positioning area comprises a visual representation of a listening environment associated with the home audio playback system, and
wherein the positioning area comprises a movable control object which represents at least one of said one or more audio objects, the movable control object being movable with respect to the visual representation of the listening environment, whereby a current location of the movable control object can be selected by a user, the current location of the movable control object being representative of a user-desired playback position within the listening environment for the at least one of the one or more audio objects,
receiving an input signal from the user via an input device, the input signal comprising data representative of the user-desired playback position for the at least one of the one or more audio objects; and
generating a configuration signal for configuring the home audio playback system, the configuration signal comprising data suitable for causing the home audio playback system to playback the at least one of the audio objects according to the user-desired playback position for the at least one of the one or more audio objects.

2. The method of claim 1, wherein the positioning area comprises a first visual element with a visual indication that the at least one of the one or more control objects has been selected by the user.

3. The method of claim 1 or claim 2, wherein the positioning area comprises a second visual element with a visual indication that the movable control object is movable, or wherein the first visual element comprises the visual indication that the movable control object is movable.

4. The method of any one of claims 2 to 3, wherein the first visual element comprises a visual indication when the control object is active.

5. The method of any one of the preceding claims, wherein the positioning area further comprises:
a further visual element arranged to indicate at least one valid location with respect to the visual representation of where the one or more speakers are located, the valid location being a location which the movable control object can occupy.

6. The method of any preceding claim, comprising determining a respective content of the, or each of the, audio objects.

7. The method of claim 6, wherein the respective content is any one of:
representative of commentary;
representative of crowd noise;
representative of team radio; or
representative of social media chat.

8. The method of any one of the preceding claims, wherein the graphical user interface further comprises an object selection list area wherein the object selection list area comprises:
at least one selectable control object, the at least one selectable control object being configured to allow the user to enable playback of one or more of the control objects.

9. The method of claim 8, wherein the object selection list area comprises at least one further selectable control object, the at least one further selectable control object being configured to allow the user to select a playback volume of the one or more enabled control objects.

10. The method of claim 8 or claim 9, wherein the object selection list area comprise plural control objects, and the control objects are arranged into plural groups in the object selection list area.

11. The method of claim 10, when dependent on claim 6 or claim 7, wherein the number of control objects in the groups is based on the respective content of the control objects.

12. The method of claim 10, or 11 when dependent on claim 6 or claim 7, wherein the allocation of the control objects to the groups is based on the respective content of the control objects.

13. The method of claim 1, wherein the home audio playback system receives information related to the audio, the audio-related information comprising resources specific for a current program of the audio, wherein the resources comprise images for icons to be displayed in association with the control object(s) in the object selection list area and/or in the positioning area.

14. The method of claim 13, wherein the resources are downloaded through a file transfer protocol (FTP) link.

15. The method of any preceding claim, wherein the home audio playback system comprises two or more speakers which are arranged according to one of:
a 2.0 speaker configuration,
a 5.1 speaker configuration,
a 7.1 speaker configuration,
a 3D speaker configuration or
a sound bar speaker configuration.

16. The method of claim 3 or any preceding claim that depends on claim 3, comprising determining, from the input signal, a user command to store:
the selection of the one of the control objects as a preset.

17. The method of any one of the preceding claims, comprising determining, from the input signal, a user command to store:
the user-desired playback position as a preset.

18. The method of claim 1, comprising communicating the configuration signal to the home audio playback system.

19. The method of claim 18, comprising communicating the configuration signal to the home audio playback system using an Internet-based protocol.

20. A method of configuring playback of audio via a home audio playback system, the audio comprising two or more audio objects, the method comprising:
generating an output signal for a display, the output signal comprising data representing a graphical user interface, the graphical user interface comprising a balance adjustment area, wherein the balance adjustment area comprises:
a first icon at a first position, the first icon representing one or more of the audio objects which are foreground objects,
a second icon at a second position, the second icon representing one or more of the audio objects which are background objects,
a movable control object which is movable between the first position and the second position whereby a current position of the movable control object can be selected by the user, the current position of the movable control object relative to the first position being representative of a user-selected volume level for the one or more foreground objects, the current position of the movable control object relative to the second position being representative of a user-selected volume level for the one or more background objects;
receiving an input signal from the user via an input device, the input signal comprising data representative of the user-selected volume level for the one or more foreground objects and data representative of the user-selected volume level for the one or more background objects; and
generating a configuration signal for configuring the home audio playback system, the configuration signal comprising data suitable for causing the home audio playback system to playback the two or more audio objects according to the respective user-selected volume levels for the one or more foreground objects and the one or more background objects.

21. The method of claim 20, comprising determining from the input signal, a user command to store:
the one or more background objects and the one or more foreground objects as presets;
the volume level of the background objects as a preset; and
the volume level of the foreground objects as a preset.

22. The method of claim 20 or 21, wherein the two or more speakers of the home audio playback system are arranged according to one of:
a 2.0 speaker configuration,
a 5.1 speaker configuration,
a 7.1 speaker configuration,
a 3D speaker configuration or
a sound bar speaker configuration

23. The method of claim 20, wherein the movable control object comprises a slider which is movable in a straight line between the first and second positions.

24. The method of claim 20, comprising communicating the configuration signal to the audio playback system.

25. The method of claim 24, comprising communicating the configuration signal to the home audio playback system using an Internet-based protocol.

26. An apparatus for configuring playback of audio via a home audio playback system, the audio comprising one or more audio objects, the apparatus comprising a processor configured to:
generate an output signal for a display, the output signal comprising data representing a graphical user interface, the graphical user interface comprising a positioning area, wherein the positioning area comprises a visual representation of a listening environment associated with the home audio playback system, and
wherein the positioning area comprises a movable control object which represents at least one of said one or more audio objects, the movable control object being movable with respect to the visual representation of the listening environment, whereby a current location of the movable control object can be selected by a user, the current location of the movable control object being representative of a user-desired playback position within the listening environment for the at least one of the one or more audio objects,
receive an input signal from the user via an input device, the input signal comprising data representative of the user-desired playback position for the at least one of the one or more audio objects; and
generate a configuration signal for configuring home audio playback system, the configuration signal comprising data suitable for causing the home audio playback system to playback the at least one of the audio objects according to the user-desired playback position for the at least one of the one or more audio objects.

27. The apparatus of claim 26, wherein the positioning area comprises a first visual element with a visual indication that the at least one of the one or more control objects has been selected by the user.

28. The apparatus of claim 26 or 27, wherein the positioning area comprises a second visual element with a visual indication that the movable control object is movable, or, wherein the first visual element comprises the visual indication that the movable control object is movable.

29. The apparatus of any one of claims 27 to 28, wherein the first visual element comprises a visual indication when the control object is active.

30. The apparatus of any one of claims 26 to 29, wherein the positioning area further comprises:
a further visual element arranged to indicate at least one valid location with respect to the visual representation of where the one or more speakers are located, the valid location being a location which the movable control object can occupy.

31. The apparatus of any one of claims 26 to 30, configured to determine a respective content of the, or each of the, audio objects.

32. The apparatus of claim 31, wherein the respective content is any one of:
representative of commentary;
representative of crowd noise;
representative of team radio; or
representative of social media chat

33. The apparatus of any one of claims 26 to 32, wherein the graphical user interface further comprises an object selection list area, wherein the object selection list area comprises: at least one selectable control object, the at least one selectable control object being configured to allow the user to enable playback of one or more of the control objects.

34. The apparatus of claim 33, wherein the object selection list area comprises at least one further selectable control object, the at least one further selectable control object being configured to allow the user to select a playback volume of the one or more enabled control objects.

35. The apparatus of claim 33 or claim 34, wherein the object selection list area comprises plural control objects, and the control objects are arranged into plural groups in the object selection list area.

36. The apparatus of claim 35, when dependent on claim 31 or claim 32, wherein the number of control objects in the groups is based on the respective content of the control objects.

37. The apparatus of claim 36, or claim 35 when dependent on claim 31 or claim 32, wherein the allocation of the control objects to the groups is based on the respective content of the control objects.

38. The apparatus of claim 26, wherein the home audio playback system is configured to receive information related to the audio, the audio-related information comprising resources specific for a current program of the audio, wherein the resources comprise images for object icons to be displayed in association with the control object(s) in the object selection list area and/or in the positioning area.

39. The apparatus of claim 39, wherein the resources are downloaded through a file transfer protocol (FTP) link.

40. The apparatus of any one of claims 26 to 39, wherein the home audio playback system comprises two or more speakers which are arranged according to one of:
a 2.0 speaker configuration,
a 5.1 speaker configuration,
a 7.1 speaker configuration,
a 3D speaker configuration or
a sound bar speaker configuration.

41. The apparatus of claim 28 or any claim that depends on claim 28, configured to determine, from the input signal, a user command to store:
the selection of the one of the control objects as a preset.

42. The apparatus of any one of claims 26 to 41, configured to determine, from the input signal, a user command to store:
the user-desired playback position as a preset.

43. The apparatus of claim 26, comprising communicating the configuration signal to the home audio playback system.

44. The apparatus of claim 43, comprising communicating the configuration signal to the home audio playback system using an Internet-based protocol.

45. The apparatus of claim 26, wherein the apparatus is suitable to receive the input signal via a wireless communications channel such as an IR-channel.

46. The apparatus of claim 26, wherein the apparatus is suitable to transmit the output signal via a wired channel such as HDMI, VGA, DVI or SCART cable.

47. The apparatus of claim 26, wherein the display and the input device are integrated in a touch screen.

48. An apparatus of configuring playback of audio via a home audio playback system, the audio comprising two or more audio objects, the apparatus comprising a processor configured to:
generate an output signal for a display, the output signal comprising data representing a graphical user interface, the graphical user interface comprising a balance adjustment area, wherein the balance adjustment area comprises:
a first icon at a first position, the first icon representing one or more of the audio objects which are foreground objects,
a second icon at a second position, the second icon representing one or more of the audio objects which are background objects,
a movable control object which is movable between the first position and the second position whereby a current position of the movable control object can be selected by the user, the current position of the movable control object relative to the first position being representative of a user-selected volume level for the one or more foreground objects, the current position of the movable control object relative to the second position being representative of a user-selected volume level for the one or more background objects;
receive an input signal from the user via an input device, the input signal comprising data representative of the user-selected volume level for the one or more foreground objects and data representative of the user-selected volume level for the one or more background objects; and
generate a configuration signal for configuring the home audio playback system, the configuration signal comprising data suitable for causing the home audio playback system to playback the two or more audio objects according to the respective user-selected volume levels for the one or more foreground objects and the one or more background objects.

49. The apparatus of claim 48, configured to determine from the input signal, a user command to store:
the one or more background and the one or more foreground objects as presets;
the volume level of the background objects as a preset; and
the volume level of the foreground objects as a preset.

50. The apparatus of claim 48 or claim 49, wherein the two or more speakers of the home audio playback system are arranged according to one of:
a 2.0 speaker configuration,
a 5.1 speaker configuration,
a 7.1 speaker configuration,
a 3D speaker configuration or
a sound bar speaker configuration

51. The apparatus of claim 48, wherein the movable control object comprises a slider which is movable in a straight line between the first and second positions.

52. The apparatus of claim 48, comprising communicating the configuration signal to the audio playback system.

53. The apparatus of claim 52, comprising communicating the configuration signal to the home audio playback system using an Internet-based protocol.

54. The apparatus of claim 48, wherein the apparatus is suitable to receive the input signal via a wireless communications channel such as an IR-channel.

55. The apparatus of claim 48, wherein the apparatus is suitable to transmit the output signal via a wired channel such as HDMI, VGA, DVI or SCART cable.

56. The apparatus of claim 48, wherein the display and the input device is integrated in a touch screen.

57. A home audio playback system comprising the apparatus of any of claims 26-56.

58. A broadcasting system comprising a broadcaster and one or more playback systems of claim 57.

59. A computer readable medium having stored thereon a plurality of computer-interpretable instructions which, when executed by a processor, causes the processor to perform the method of any of claims 1-19.

60. A computer readable medium having stored thereon a plurality of computer-interpretable instructions which, when executed by a processor, causes the processor to perform the method of any of claims 20-25.
